(19) United States
(12) Patent Application Publication
(10) Pub. No.: US 2017/0161498 A1
(43) Pub. Date: Jun. 8, 2017

(54) SYSTEMS AND METHODS FOR DETECTION OF MALICIOUS CODE IN RUNTIME GENERATED CODE

(71) Applicant: enSilo Ltd., Herzlia (IL)

(72) Inventor: Udi YAVO, Herzlia (IL)

(21) Appl. No.: 15/257,935

(22) Filed: Sep. 7, 2016

Related U.S. Application Data
(60) Provisional application No. 62/264,404, filed on Dec. 8, 2015.

(51) Int. Cl. G06F 21/56

(52) U.S. Cl. CPC G06F 21/566

(57) ABSTRACT

According to an aspect of some embodiments of the present invention there is provided a computer-implemented method for detection of malicious code within runtime generated code executing within a computer, comprising executing on a processor of the computer the acts of: receiving an indication of at least one of the creation and the execution of runtime generated code in a memory of a computer; identifying a match between signature data associated with the runtime generated code and a template signature of a plurality of templates representing authorized source creation modules that created the runtime generated code, the templates stored in a repository on a storage device; and triggering a security process to handle malicious code in the runtime generated code when no match is found.

### RELATED APPLICATION

This application claims the benefit of priority under 35 USC §119(e) of U.S. Provisional Patent Application No. 62/264,404 filed on Dec. 8, 2015, the contents of which are incorporated herein by reference in their entirety.

### FIELD AND BACKGROUND OF THE INVENTION

The present invention, in some embodiments thereof, relates to detection of malicious code and, more specifically, but not exclusively, to detection of malicious code in runtime generated code.

In contrast to code of a running program loaded from executable files stored on a storage device (e.g., hard drive) to a memory (e.g., random access memory (RAM)) for execution by a processor, code may be generated during runtime. For example, runtime generated code may be created by a Just-In-Time (JIT) compiler, which compiles source code or byte code to machine code and executes it during runtime.

Runtime generated code may be benign, or may be used by malicious code, for example, malware and shellcodes. Malicious code may generated in runtime to help evade detection, for example, to disassociate the runtime generated code from files (e.g., stored on the hard disk) to prevent security programs from identifying the source file, to inject code into other processes, and to morph its own code in memory to avoid detection based on signatures.

### SUMMARY OF THE INVENTION

According to an aspect of some embodiments of the present invention there is provided a computer-implemented method for detection of malicious code within runtime generated code executing within a computer, comprising executing on a processor of the computer the acts of: receiving an indication of at least one of the creation and the execution of runtime generated code in a memory of a computer; identifying a match between signature data associated with the runtime generated code and a template signature of a plurality of templates representing authorized source creation modules that created the runtime generated code, the templates stored in a repository on a storage device; and triggering a security process to handle malicious code in the runtime generated code when no match is found.

Optionally, the template signature represents an authorized just in time (JIT) compiler.

Optionally, identifying the match between the signature data and the template signature comprises at least one of: identifying an association between a first executable module called by the runtime generated code to invoke an operating system function, and the template representing the authorized JIT compiler, and identifying an association between a second executable module creating the runtime generated code and the template representing the authorized JIT compiler.

Optionally, the signature data comprises a predefined size of an area in the memory storing the runtime generated code. Alternatively or additionally, the signature data comprises a designation of a memory region storing the runtime generated code as read-only or no-access. Alternatively or additionally, the signature data comprises at least one code pattern.

Optionally, wherein the at least one code pattern includes at least one member selected from the group consisting of: at least one predefined prolog at a start region of at least one function of the runtime generated code, at least one epilogue, and at least one magic operand value.

Alternatively or additionally, the signature data comprises predefined control structures related to the JIT compiler at least one of at a start region and an end region of the runtime generated code.

Optionally, the predefined control structures include at least one of: a linked list at each of a plurality of different memory regions each storing a portion of the runtime generated code, and fields defining size and address of the respective memory region located after the respective linked list. Optionally, the linked list is verified by traversing pointers of each memory region, and the fields are verified by correlating the values of the fields with operating system values.

Alternatively or additionally, the signature data comprises an application associated with the runtime generated code to which the authorized JIT complier is restricted.

Optionally, the template signature represents an authorized hook engine.

Optionally, the signature data includes identification that the runtime generated code is created by a hook engine, the identifying performed by at least one of: emulating preexisting code at the prolog of a hooked module to reach outside code residing outside of the hooked module; and analyzing a stack trace related to the outside code to identify the runtime generated code by locating the position of the runtime generated code as appearing in the stack trace before the authorized hook engine executable that installed the hook.

Alternatively or additionally, the signature data includes at least one member selected from the group consisting of: a predefined size of the memory area where the runtime generated code resides, at least one code pattern, predefined control structures at least at one of at a start portion and an end portion of the runtime generated code memory region, and an opcode signature calculated from assembly obtained by applying a disassemble program to the runtime generated code excluding mutable parameters.

Optionally, the at least one code pattern includes at least one member selected from the group consisting of: at least one predefined prolog at a start region of at least one function of the runtime generated code, at least one epilogue, and at least one magic operand value.

Optionally, the template signature represents an authorized executable compressor.

Optionally, the signature data includes at least one member selected from the group consisting of: size of a memory allocation according to a format of the decompressed executable file, a cryptographic hash function calculated over immutable portions of the executable file structure and code, and permissions on memory pages where the decompressed executable file resides.

Optionally, the method further comprises verifying that contents of the memory at the base of the memory allocation is according to the format of the decompressed executable file by parsing contents of the memory allocation according to the format of the decompressed executable file, and checking that field values are logical and conform to the format.

According to an aspect of some embodiments of the present invention there is provided a system for detection of runtime generated code containing malicious code, comprising: a memory for storing code; a storage device for storing a repository of templates representing authorized source creation modules that create runtime generated code; a program store storing code; and a processor coupled to the memory, the storage device, and the program store for implementing the stored code, the stored code comprising: stored code to receive an indication of at least one of the creation and the execution of runtime generated code in the memory, identify a match between signature data associated with the runtime generated code and a template signature of the repository; and trigger a security process to handle malicious code in the runtime generated code when no match is found.

According to an aspect of some embodiments of the present invention there is provided a computer program product comprising a non-transitory computer readable storage medium storing program code thereon for implementation by a processor of a system for detection of runtime generated code containing malicious code, the program code comprising: instructions to receive an indication of at least one of the creation and the execution of runtime generated code in a memory of a computer; instructions to identify a match between signature data associated with the runtime generated code and a template signature of a set of templates representing authorized source creation modules that create runtime generated code; and instructions to trigger a security process to handle malicious code in the runtime generated code when no match is found.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a computer implemented method for detection of malicious code within runtime generated code, in accordance with some embodiments of the present invention;

FIG. 2 is a block diagram of components of a system that detects malicious code within runtime generated code, in accordance with some embodiments of the present invention; and

FIG. 3 is a flowchart of a method of identifying a match between signature data of the runtime generated code and a template signature representing an authorized source creation module, in accordance with some embodiments of the present invention.

### DESCRIPTION OF SPECIFIC EMBODIMENTS OF THE INVENTION

The present invention, in some embodiments thereof, relates to detection of malicious code and, more specifically, but not exclusively, to detection of malicious code in runtime generated code.

An aspect of some embodiments of the present invention relates to code executable by a processor, that detects malicious code (e.g., malware, shellcode, and other malicious code) within runtime generated code stored in a physical memory (e.g., random access memory (RAM)) and implementable by the processor.

Optionally, the malicious code is detected by exclusion. A match between signature data associated with the runtime generated code is identified with a template signature of a set of templates representing authorized (i.e., safe and/or allowed) modules that create runtime generated code. The runtime generated code is presumed to be safe when the match is found, for example, the template appears within a white-list representing authorized source creation modules. When no match is found, the runtime generated code may be presumed to be malicious. Optionally, a security process is triggered in response to the lack of the match to handle the malicious code, for example, a program to remove the malicious code. In this manner, the systems and/or methods described herein improve the ability to identify runtime generated code containing malicious code within a memory of a computer.

Optionally, the presence of malicious code within the runtime generated code is excluded by identifying match with a template signature representing an authorized just in time (JIT) compiler that creates the runtime generated code as part of a runtime compilation processes, for example, JAVA®, DOTNET™, and JavaScript® engines. In this manner, the runtime generated code is presumed to be the compiled instructions generated by the authorized compiler.

Alternatively, the presence of malicious code within the runtime generated code is excluded by identifying a match with a template signature representing an authorized hook engine. Such hook engines may create runtime generated code to alter program behavior, for example, anti-virus and other security applications. In this manner, the runtime generated code is presumed to be the creation of the safe and/or allowed hook engine.

Alternatively, the presence of malicious code within the runtime generated code is excluded by identifying a match with a template signature representing an authorized executable compressor (i.e. sometimes termed a software packer) that decompresses code and executes the decompressed code. The created and/or executing runtime generated code may be used by the software packer to map the compressed executable file into a memory location instead of and/or without using operating system loaders.

Optionally, signature data associated with the runtime generated code used for matching with the template may include, for example, one or more of: predefined memory size for storing the runtime generated code, predefined code pattern(s) (for example, unique prolog(s), epilogue(s), and magic operand value(s)) within the runtime generated code, and assigned permissions associated with memory regions (e.g., pages) storing the runtime generated code.

It is noted that the match between the signature data and the template may be complete (i.e., 100% match), or partial (i.e., less than 100% match), for example, a correlation value. Less than complete correlation and/or partial matches may be used, for example, according to a probability threshold. For example, a partial match with a template associated with a probability value of 70% and above the threshold of 50% may trigger the security process.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

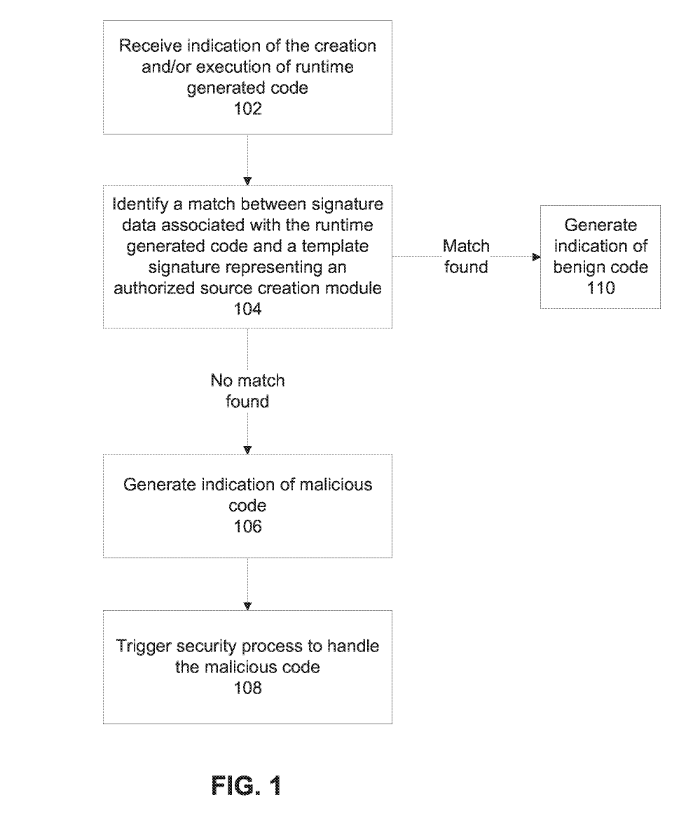

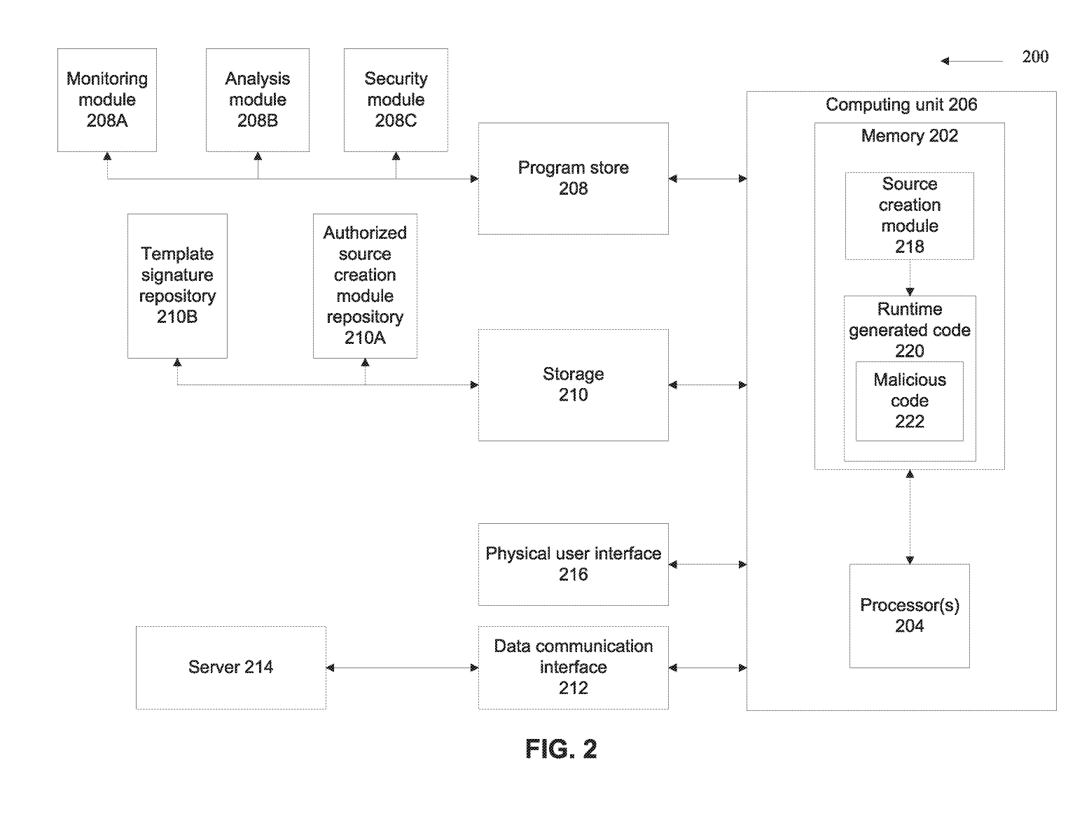

Reference is now made to FIG. 1, which is a flowchart of a computer implemented method for detection of malicious code within runtime generated code, in accordance with some embodiments of the present invention. Reference is also made to FIG. 2, which is a block diagram of components of a system that automatically identifies matches between signature data associated with runtime generated code and a template signature to identify the runtime generated code as malicious code and/or to exclude the runtime generated code as including malicious code, in accordance with some embodiments of the present invention. The method of FIG. 1 may be implemented by the system of FIG. 2.

The systems and/or methods described herein relate to the technical problem of identification of malicious code contained within runtime generated code executing on a memory of a computer. The systems and/or methods described herein relate to software technology for identification of malicious code contained within runtime generated code stored on a memory of a computer, and implemented by a processor of the computer. The identification of the malicious code may trigger a process executable by a processor to remove and/or isolate the malicious code. As such, the systems and/or methods described herein are inextricably tied to computer technology. The systems and/or methods described herein may improve performance of the computer (e.g., improvement in processor and/or memory utilization), by identifying malicious code, which allows blocking, removal, and/or isolation of the code, reducing and/or preventing damage to the computer (e.g., due to the malicious code utilizing existing processing and/or memory resources).

System 200 includes one or more memory structures 202, for example, a random access memory (RAM), a primary storage, a main memory, an internal memory, a virtual memory (e.g., accessing secondary storage), and/or other physical memory structures (which may be abstractly linked together).

Memory 202 is directly accessible to one or more processors 204 in communication with memory 202, which implement instructions stored within memory 202 (e.g., as machine code). Processors 204 may include for example, a central processing unit (CPU), a graphics processing unit (GPU), field programmable gate arrays (FPGA), digital signal processor (DSP), and application specific integrated circuits (ASIC). Processors 204 (homogenous or heterogeneous), may be arranged for parallel processing, as clusters and/or as one or more multi core processing units, or may be independent of one another.

Memory 202 and processors 204 may be implemented as one or more computing units 206, for example, a personal computer, a mobile device (e.g., Smartphone, Tablet), a wearable device (e.g., computing glasses, computing watch), and/or a server.

Computing unit 206 may include and/or be associated with a program store 208 storing code implementable by processor 204. Program store 208 may be implemented by memory 202, and/or may be implemented by secondary storage 210 that store instructions no directly available to processor 204 (i.e., require loading into memory 202 for implementation), for example, a storage device, for example, non-volatile memory, magnetic media, semiconductor memory devices, hard drive, removable storage, and optical media (e.g., DVD, CD-ROM). Instructions to implement the method of FIG. 1 may be stored as code in program store 208.

Computing unit 206 may include one or more data communication interfaces 212 to communicate with external devices and/or components, for example, with a network, with a server, with another computer, with storage devices, and/or other devices and/or components. For example, computing unit 206 may access a remote server 214 (e.g., over a network) to download new signatures used in detection of authorized runtime generated code (as described herein), and/or a white-list of updated authorized source creation modules.

Computing unit 206 may include a physical user interface 216, for example, one or more of: a display, a touch screen, a keyboard, a mouse, and voice activated interface. Indications of detected malicious code may be displayed to a user using a screen (i.e., interface 21′6). The user may select to perform further action on the detected malicious code, for example, to execute a malicious code removal process.

Blocks of the method of FIG. 1 may be represented as instructions in code stored in program store 208, implementable by processing unit 204.

At 102, an indication (e.g., a signal, an internal message, a network message) of the creation and/or execution of runtime generated code in memory 202 of computing device 206 is received by processing unit 204.

The indication may be received from code (e.g., a monitoring module) that monitors and/or identifies the creation and/or execution of runtime generated code.

The monitoring may be performed by code stored in program store 208 (e.g., monitoring module 208A), implementable by processor 204.

The following exemplary methods may be used to detect the creation and/or execution of runtime generated code. The described methods are not meant to be necessarily limiting, as other methods may be used. For example, runtime generated code may be detected as part of a stack tracing process. For example, when a process tries to create a new connection, monitoring module 208A walks the stack and identifies all code associated with the connection establishment. Whenever a code that is not associated with a file is detected, a check for malicious runtime generated code is made. In another example, the creation of runtime generated code is detected by monitoring operating systems functions that alter data to code or create new executable memory. Execution of runtime generated code may be detected using processor specific features, for example, branch tracing.

A source creation module 218, which may be a benign module (i.e., authorized, safe and/or allowed process) or a malicious module generates runtime generated code 220. The created runtime generated code may be benign (i.e., authorized, safe and/or allowed process), or may include malicious code 222 (e.g., code designed to perform malicious acts, for example, damaging the computer, reducing performance of the computer, theft of information, and/or allowing a remote user to control the computer).

As used herein, the term source creation module means code associated with an executable file, for example, an operating system file called by the application, and/or a dynamically linked library (DLL) file, and/or an .EXE file. The code may be part of an application associated with the executable file.

It is noted that malicious code may be generated in the context of benign process. The systems and/or methods described herein may detect generation and/or execution of malicious code in the context of benign process, by excluding a template signature indicative of the benign runtime generated code. For example, when no match is found with a template signature indicative of the benign runtime generated code.

Source creation module 218 currently residing in memory 202 (which may have been loaded from storage 210) creates the runtime generated code dynamically, during execution of the source creation module. The runtime generated code may be created and stored within memory 202, optionally in machine language, ready for execution by processor 204. The runtime generated code may be created and stored within a virtual memory for execution by a virtual machine.

At 104, a match is identified between signature data associated with runtime generated code 210 and a template signature, optionally from template signature repository 210B stored on storage 210. The template signatures represent authorized source creation modules that created the runtime generated code. A list of the authorized source creation modules may be stored in repository 210A stored on storage 210. The identification may be performed by code stored in program store 208 (e.g., analysis module 208B), implementable by processor 204.

The templates may be used as a white-list for the runtime generated code. The runtime generated code may be allowed to execute (or continue executing) when a member of the white-list has been identified. When no member of the white-list has been identified, the runtime generated code may be blocked or prevented from executing, for example, until a security program evaluates the runtime generated code for the presence of malicious code. The templates and/or authorized source creation modules may be obtained and/or updated, for example, by accessing remote server 214.

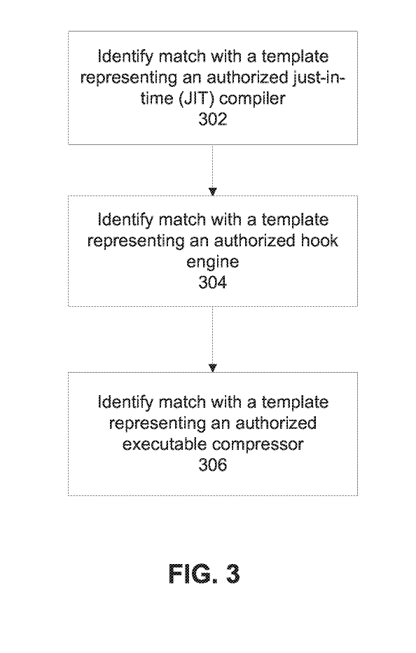

Reference is now made to FIG. 3, which is a flowchart of a method of identifying a match between signature data of the runtime generated code and a template signature representing an authorized source creation module, in accordance with some embodiments of the present invention. The method attempts to find a match with a template representing an authorized JIT compiler, a hook engine, and/or an executable compressor that created the runtime generated code. The method collects signature data based on the runtime generated code itself, data related to the runtime generated code, data related to the memory storing the runtime generated code, and/or other parameters, to attempt to match the signature data to a template. The template may represent a certain source creation module (which may be a member of one of the general categories of source creation modules) and/or the template may represent a general category of source creation modules. The malicious code may be identified by failure to find a match.

At 302, a match is identified between the signature data and an authorized just in time (JIT) compiler that created the runtime generated code. The JIT compiler performs compilation (e.g., of source code, or bytecode) dynamically during execution of the program (i.e., during runtime) to create the runtime generated code (e.g., in machine readable format), which is executed by the processor.

The signature data may include identification of the presence of one or more executable modules of the JIT compiler loaded in memory 202. The executable module may generate the runtime generated code. The executable module and/or the JIT compiler may be called by the runtime generated code to invoke an operating system function, such as when the runtime generated code does not directly interact with the operating system. The executable module may call the runtime generated code. Identification of the executable module may be used as the signature data for matching to the template representing the related JIT compiler. Identification of the executable module may match with the template representing the JIT compiler when the JIT compiler includes the executable module (e.g., the JIT compiler and the executable module are the same). The executable module may be identified, for example, by verifying the presence of a related file in storage 210, for example, verifying the file JVM.dll may be used as a signature to identify an association with the JAVA® JIT compiler.

The signature data may include predefined memory structures used by respective JIT compilers to manage regions of memory 202 allocated for storage of the runtime generated code. Different JIT compilers may have different predefined memory structures. Identification of the predefined memory structures may be used as signature data for matching to the template signature representing the related JIT compiler.

The signature data may include a predefined size of an area in memory 202 storing the runtime generated code. Different JIT compilers may use different predefined sizes, for example, constant code chunk sizes may be used as a signature for the JIT compilers known to use the respective chunk size. For example, some versions of Dotnet™ JIT compiler use code chunks of size 0x10000. Therefore, identifying that the runtime generated code is stored in chunks of size 0x10000 may be used as signature data to match with the template signature representing the Dotnet™ JIT compiler.

The signature data may relate to the mechanism of generation of the runtime generated code by respective JIT compilers. Different JIT compilers may have different predefined mechanisms for generation of the runtime generated code. Identification of the mechanism of generation of the runtime generated code may be used as signature data for matching with the template signature representing the related JIT compiler.

The signature data may relate to one or more memory regions storing the runtime generated code designated as read-only or no-access. Different JIT compilers may designate the memory regions storing the runtime generated code as read-only or no-access, for example, as a security measure to prevent modification of the newly created code. The designation may be used as signature data to match with a template signature representing a generate category of authorized JIT compilers, for example, when different JIT compilers use the same designation. For example, JIT compilers may set protection of the memory segments (e.g., memory pages) as read-only, while it is noted that malicious code may designate their respective runtime generated code as writable. The designation may be used as signature data to match with a template representing a certain JIT compiler, for example, when certain JIT compilers use certain designations. For example, the V8 JIT compiler may set the designation of some pages of the runtime generated code to no-access. The no-access designation may make it more difficult for attackers (e.g., human or software) to exploit the code.

The signature data may relate to one or more code patterns, for example, predefined prologs at the start region of one or more functions of the runtime generated code, epilogue(s), and/or magic operand value(s). The predefined prolog may be used as signature data to match with a template signature representing the authorized JIT compiler that created the runtime generated code. For example, prologs that start by pushing a magic value to the stack may be associated with a certain authorized JIT compiler.

The signature data may relate to one or more predefined control structures related to the JIT compiler. The code structures may be located at a start region and/or at an end region of memory portion storing the runtime generated code. The predefined control structures may include a linked list at each of the different memory regions that store a portion of the runtime generated code. The predefined control structures may include fields defining the memory size and/or memory address of the respective memory region located after the respective linked list. For example, the V8™ JIT compiler links code regions of the runtime generated code using linked lists located at the base of each respective code region. The linked list of the V8™ JIT compiler is followed by the following fields: size of the respective memory region, control flags for the memory region, the address where the memory region starts, and the address where the memory region ends. By identifying the linked list structures and/or one or more of the related fields, the signature data may be matched with the template signature representing the V8™ JIT compiler.

Validation that the control structure exists in respective code regions may be performed by correlating the detected value with predefined operating system values. For example, the size of the code region may be detected based on the control structure, and correlated with the predefined size specified by the operating system. In another example, the start and end addresses of each region may be detected (e.g., from the control structure) and correlated with operating system configurations. A match validates the control structure. The linked list may be verified by traversing from one memory region to another using the pointers between regions. Each pointer may be followed to verify that the pointer actually points to a valid code region, and that the previous pointer of the code actually points back to the original code region.

Inability to verify the control structure may suggest that the runtime generated code may include malicious code, and/or has been created by a malicious source creation module.

The signature data may relate to an application or process that is known to be associated with the runtime generated code. The authorized JIT complier may be known to be restricted to the application or process. For example, identifying the Firefox™ Browser as associated with the runtime generated code may be used as signature data to match to the template signature representing the JaegerMonkey JIT compiler as the source creation module, based on the restriction of the JaegerMonkey JIT compiler to the Firefox™ Browser.

Alternatively, at 304, a match is identified between the signature data and a template signature representing an authorized hook engine that created the runtime generated code. Authorized hook engines may create runtime generated code, for example to patch preexisting code to redirect the execution of the existing code to the code of the hook engine or to the runtime generated code created by the hook engine.

The signature data may include an identification that the runtime generated code is created by a hook engine. The identification may be performed by emulating the preexisting code at the prolog of the hooked module to determine where the hook leads to, for example, the code may be emulated by a virtual machine executing within a sandbox, and/or by a code emulator. The code is emulated and monitored until code that resides outside of the hooked module is reached. The outside code may be runtime generated code created by the hook engine, or an executable that installed the hook (e.g., the hook engine). The case of the outside code being the runtime generated code may be determined, for example, by verifying whether the outside code resides within the address space of the runtime generated code. When the outside code is the executable, the association between the executable and the runtime generated code may be verified by analyzing a stack trace. The stack trace related to the hooked function and/or to the outside code may be analyzed to identify a reference of the runtime generated code in the stack trace, by locating the position of the reference to the runtime generated code in the stack trace before the authorized hooking engine executable that installed the hook.

When the runtime generated code has been found to be associated (i.e., created by) the hook engine, the signature data is matched to a template signature representing an authorized hook engine. The match may determine whether the runtime generated code was created by an authorized class of hook engines, without necessarily identifying the certain hook engine that created the runtime generated code, for example, based on one or more properties shared by the authorized engines. The match may determine the certain authorized hook engine that created the code, for example, based on a property unique to the certain hook engine.

Optionally, the signature data are indicative of the authorized hooking engine, or class of authorized engines. For example, the signature data may be matched with a template signature of an authorized hook engine (or class of engines) stored in signature repository 210B. The template signatures in signature repository 210B may be automatically and/or manually retrieved, for example, by downloading from server 214 over a network. Server 214 may provide updates to the signatures.

Exemplary signature data may include one or more of:
A predefined size of the memory area where the runtime generated code resides. Authorized engines (as a class or individually) may write code in a predefined code chunk size, for example, size 0x1000.
One or more predefined prologs at the start of one or more functions of the runtime generated code. For example, a certain anti-virus hook engine may use the opcode push MagicValue at the beginning of each chunk of runtime generated code created by the anti-virus hook engine.
One or more predefined control structures located at the start region and/or end region of the memory region(s) storing the runtime generated code. For example, a linked list that links different memory region each storing a portion of the runtime generated code.
An opcode signature generated using a disassembler program. The disassembler may be applied to the assembly of the runtime generated code excluding mutable parameters, for example, addresses. The disassembler may be applied after the mutable parameters have been removed from the runtime generated code.

At 306, and the signature data is matched with a template signature representing an authorized executable compressor that created the runtime generated code. Executable files may be compressed together with decompression code into a single executable. When the compressed executable is executed, the decompression code decompresses the data and reconstructs the original (i.e., pre-compressed) program. The decompressor may write the decompressed code directly into the memory, by mapping the decompressed code directly into the memory.

The content of the memory region storing the runtime generated code is verified according to a predefined operating system format associated with the executable compressor. Each executable file has an associated predefined operating system format, which is present in the memory when the compressed file is mapped into the memory. Contents of the memory at the base of the memory allocation storing the de-compressed program are verified according to the format of the de-compressed executable file. The verification may be performed by parsing contents of the memory allocation according to the format of the decompressed executable file. Field values may be checked as being logical and conforming to the format.

Exemplary signature data may include one or more of:
A predefined size of the memory allocated for storing the runtime generated code (i.e., the decompressed program) according to the predefined format associated with the executable compressor. Authorized compressors (as a class or individually) may write code in predefined code chunk sizes.
A hash function (optionally a cryptographic hash function) calculated over immutable portions of the executable file structure and/or code. The value(s) outputted by the hash function may be mapped to one or more authorized executable compressors.
Permission designation of memory pages where the decompressed runtime executable code is stored in memory. The permission designation may be indicative of a class of authorized executable compressors. For example, the created runtime generated code may be designated as read-only.

At 106, an indication of the presence of malicious code in the runtime generated code may be generated when no match is found between the signature data a template signature. The indication may be, for example, an internal message communication from the analysis module to a security program, to trigger activation of the security program to investigate the runtime generated code for malicious code. The indication may be, for example, a message displayed on a screen to a user, alerting the user that possible malicious code has been found.

Alternatively or additionally, an indication that the runtime generated code is associated with an authorized source creation module is generated when the match is found with the template signature representing the authorized source creation module (e.g., in general, or a certain process). The indication may be, for example, an internal message communicated from one process to another, such as to allow the runtime generated code to be executed (or continue execution, or prevent blockage of execution) when the runtime generated code has been analyzed to be associated with an authorized source creation module.

At 108, when the indication of the presence of (e.g., possible) malicious code in the runtime generated code is generated, one or more security measures may be trigged, automatically by code, or manually by the user (e.g., presenting on the screen a message indicating that the possibility of malicious code, and asking the user whether to activate the security process.

Examples of security measures (e.g., executable by security applications, for example, security module 208C stored on program store 208 and/or on another storage device) include: blocking further execution of the runtime generated code, deletion of the runtime generated code and/or associated source creation module, activation of an anti-malicious code security program to remove the malicious code, isolation of the runtime generated code and/or associated source creation module, and/or preventing the code from accessing other areas in memory.

Alternatively to block 106, at 110, when a match is found between the signature data associated with the runtime generated code and a template signature representing an authorized source creation module, an indication of the presence of benign code may be created. As discussed herein, finding a match indicates that the runtime generated code is associated with an authorized source creation module. The runtime generated code may be allowed to proceed, for example, when a control module receives the indication that the runtime generated code represents benign code. The control module, which may have paused execution of the runtime generated code, or monitors for the created indication, may resume execution of the runtime generation code. Alternatively, no indication is created, allowing the runtime generated code to execute.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant source creation modules, runtime generated code, and malicious code will be developed and the scope of the terms source creation modules, runtime generated code, and malicious code are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer-implemented method for detection of malicious code within runtime generated code executing within a computer, comprising executing on a processor of the computer the acts of:
receiving an indication of at least one of the creation and the execution of runtime generated code in a memory of a computer;
identifying a match between signature data associated with the runtime generated code and a template signature of a plurality of templates representing authorized source creation modules that created the runtime generated code, the templates stored in a repository on a storage device; and
triggering a security process to handle malicious code in the runtime generated code when no match is found.

2. The method of claim 1, wherein the template signature represents an authorized just in time (JIT) compiler.

3. The method of claim 2, wherein identifying the match between the signature data and the template signature comprises at least one of:
identifying an association between a first executable module called by the runtime generated code to invoke an operating system function, and the template representing the authorized JIT compiler, and
identifying an association between a second executable module creating the runtime generated code and the template representing the authorized JIT compiler.

4. The method of claim 2, wherein the signature data comprises a predefined size of an area in the memory storing the runtime generated code.

5. The method of claim 2, wherein the signature data comprises a designation of a memory region storing the runtime generated code as read-only or no-access.

6. The method of claim 2, wherein the signature data comprises at least one code pattern.

7. The method of claim 6, wherein the at least one code pattern includes at least one member selected from the group consisting of: at least one predefined prolog at a start region of at least one function of the runtime generated code, at least one epilogue, and at least one magic operand value.

8. The method of claim 2, wherein the signature data comprises predefined control structures related to the JIT compiler at least one of at a start region and an end region of the runtime generated code.

9. The method of claim 8, wherein the predefined control structures include at least one of: a linked list at each of a plurality of different memory regions each storing a portion of the runtime generated code, and fields defining size and address of the respective memory region located after the respective linked list.

10. The method of claim 9, wherein the linked list is verified by traversing pointers of each memory region, and the fields are verified by correlating the values of the fields with operating system values.

11. The method of claim 2, wherein the signature data comprises an application associated with the runtime generated code to which the authorized JIT compiler is restricted.

12. The method of claim 1, wherein the template signature represents an authorized hook engine.

13. The method of claim 12, wherein the signature data includes identification that the runtime generated code is created by a hook engine, the identifying performed by at least one of:
emulating preexisting code at the prolog of a hooked module to reach outside code residing outside of the hooked module; and
analyzing a stack trace related to the outside code to identify the runtime generated code by locating the position of the runtime generated code as appearing in the stack trace before the authorized hook engine executable that installed the hook.

14. The method of claim 12, wherein the signature data includes at least one member selected from the group consisting of: a predefined size of the memory area where the runtime generated code resides, at least one code pattern, predefined control structures at least at one of at a start portion and an end portion of the runtime generated code memory region, and an opcode signature calculated from assembly obtained by applying a disassemble program to the runtime generated code excluding mutable parameters.

15. The method of claim 14, wherein the at least one code pattern includes at least one member selected from the group consisting of: at least one predefined prolog at a start region of at least one function of the runtime generated code, at least one epilogue, and at least one magic operand value.

16. The method of claim 1, wherein the template signature represents an authorized executable compressor.

17. The method of claim 16, wherein the signature data includes at least one member selected from the group consisting of: size of a memory allocation according to a format of the decompressed executable file, a cryptographic hash function calculated over immutable portions of the executable file structure and code, and permissions on memory pages where the decompressed executable file resides.

18. The method of claim 17, further comprising verifying that contents of the memory at the base of the memory allocation is according to the format of the decompressed executable file by parsing contents of the memory allocation according to the format of the decompressed executable file, and checking that field values are logical and conform to the format.

19. A system for detection of runtime generated code containing malicious code, comprising:
a memory for storing code;
a storage device for storing a repository of templates representing authorized;
source creation modules that create runtime generated code;
a program store storing code; and
a processor coupled to the memory, the storage device, and the program store for implementing the stored code, the stored code comprising:
stored code to receive an indication of at least one of the creation and the execution of runtime generated code in the memory, identify a match between signature data associated with the runtime generated code and a template signature of the repository; and trigger a security process to handle malicious code in the runtime generated code when no match is found.

20. A computer program product comprising a non-transitory computer readable storage medium storing program code thereon for implementation by a processor of a system for detection of runtime generated code containing malicious code, the program code comprising:
instructions to receive an indication of at least one of the creation and the execution of runtime generated code in a memory of a computer;
instructions to identify a match between signature data associated with the runtime generated code and a template signature of a set of templates representing authorized source creation modules that create runtime generated code; and
instructions to trigger a security process to handle malicious code in the runtime generated code when no match is found.
